(19) United States
(12) Patent Application Publication
(10) Pub. No.: US 2021/0364802 A1
(43) Pub. Date: Nov. 25, 2021

(54) IMAGE DISPLAY DEVICE, HEAD MOUNTED DISPLAY

(71) Applicant: Hitachi-LG Data Storage, Inc., Tokyo (JP)

(72) Inventors: Masahito UCHIYAMA, Tokyo (JP); Toshiteru NAKAMURA, Tokyo (JP); Takuma KUNO, Tokyo (JP); Ryuichiro MIZUNO, Tokyo (JP); Kazuhiko KUZUMAKI, Tokyo (JP)

(21) Appl. No.: 17/233,886

(22) Filed: Apr. 19, 2021

(30) Foreign Application Priority Data
May 22, 2020 (JP) 2020-089639

(51) Int. Cl. G02B 27/01; F21V 8/00; G02C 7/16; G02B 3/10; G02C 9/04

(52) U.S. Cl. CPC G02B 27/0172; G02B 6/003; G02B 6/005; G02B 2027/0127; G02B 3/10; G02C 9/04; G02B 2027/0178; G02C 7/16

(57) ABSTRACT

An objective of the present disclosure is to provide an image display device capable of suppressing stray light and outputting a high-quality video. An image display device according to the present disclosure comprises a protective cover covering a periphery of a light guide, wherein the protective cover comprises a concave lens and a convex lens, wherein the concave lens and the light guide are disposed at intervals of 4 mm or less, and wherein the convex lens and the light guide are disposed at intervals of 5 mm or less.

### CROSS-REFERENCE TO RELATED APPLICATION

This application claims the priority of Japanese Patent Application No. 2020-089639 filed on May 22, 2020, which is incorporated herein by reference in its entirety.

### BACKGROUND OF THE DISCLOSURE

### 1. Field of the Disclosure

The present disclosure relates to an image display device for projecting an image to a user.

### 2. Description of the Related Art

Some head mounted displays are of the see-through type. The see-through type head mounted display is configured such that when worn by a user, the head mounted display transmits the external image and presents the external image to the user as well as projecting an image to the user from the head mounted display itself.

JP Patent Publication 2014-505899 A describes a visual adaptation device preferred for a see-through display. This document describes: “A method for overlaying first and second images in a common focal plane of a viewer comprises forming the first image and guiding the first and second images along an axis to a pupil of the viewer. The method further comprises adjustably diverging the first and second images at an adaptive diverging optic to bring the first image into focus at the common focal plane, and, adjustably converging the second image at an adaptive converging optic to bring the second image into focus at the common focal plane” (see Abstract).

US2017/0045742 describes: “Fixed position optical devices for displaying augmented reality images are provided herein. In one embodiment an optical device includes a AIIE having a waveguide that reflects a computer generated image along a central viewing axis, the computer generated image being received from an image generator optically coupled to the waveguide, and a fixed lens assembly for coupling a background image with the computer generated image to create the augmented reality display, the fixed lens assembly including a proximal lens disposed on one side of the waveguide, the proximal lens being fixedly spaced apart from the waveguide at a first distance, and a distal lens disposed on an opposing side of the AIIE from the one side, the distal lens being fixedly spaced apart from the waveguide at a second distance.” (see Abstract).

### SUMMARY OF THE DISCLOSURE

JP Patent Publication 2014-505899 A describes a head mounted display comprising: a concave lens on a user side in front of a light guide for outputting an image; and a convex lens on an outside of the light guide, wherein the power of both lenses are electronically adjustable. However, JP Patent Publication 2014-505899 A does not describe about an interval between the light guide and the concave lens and an interval between the light guide and the convex lens. If these intervals are not properly configured, for example, when the concave lens and the convex lens are away to some extent from the light guide, stray light may occur and the image quality may be deteriorated.

US2017/0045742 describes a head mounted display comprising: a concave lens on a user side in front of a light guide for outputting an image; and a convex lens on an outside of the light guide, wherein an interval is provided between the light guide and the concave lens, and an interval is provided between the light guide and the convex lens. However, US2017/0045742 does not specify a specific numerical value for the intervals between each lens and the light guide, and there is no description regarding stray light as in JP Patent Publication 2014-505899 A.

The present disclosure has been made in view of the problems above, and it is an objective of the present disclosure to provide an image display device capable of suppressing stray light and outputting a high-quality image.

An image display device according to the present disclosure comprises a protective cover covering a periphery of a light guide, wherein the protective cover comprises a concave lens and a convex lens, wherein the concave lens and the light guide are disposed at intervals of 4 mm or less, and wherein the convex lens and the light guide are disposed at intervals of 5 mm or less.

With the image display device according to the present disclosure, it is possible to provide an image display device capable of suppressing stray light and outputting a high-quality image. Problems, configurations, and effects other than those described above will be clarified by the following description of the embodiment.

### BRIEF DESCRIPTION OF THE DRAWINGS

FIG. 1 is a diagram illustrating a usage pattern of a head mounted display 5 equipped with an image display device 1 according to an embodiment 1.

FIG. 2 is a functional block diagram of the image display device 1.

FIG. 3 is a diagram illustrating a configuration example of a protective cover 9 and a light guide 8.

FIG. 4 illustrates two optical paths in which an image 101 outputted from the light guide 8 is incident on the concave lens 13 at an angle θa, travelling toward the user's eye 4.

FIG. 5 illustrates two optical paths in which an external scene 105 is incident on the convex lens 12, travelling toward the user's eye 4.

FIG. 6 illustrates a modified example of FIG. 3 in which a surface of the concave lens 13 at a side of the user and a surface of the convex lens 12 at an external side are planar.

FIG. 7 illustrates a modified example of FIG. 3 in which a surface of the concave lens 13 at a side of the light guide 8 and a surface of the convex lens 12 at a side of the light guide 8 are planar.

FIG. 8 illustrates a configuration example in which the protective cover 9 comprises a detachable mechanism 15 which is detachable with respect to a housing of the image display device 1.

FIG. 9 illustrates a configuration example in which the light guide 8 and the protective cover 9 are bonded together by a support 17.

FIG. 10 is a diagram illustrating a configuration example of the image display device 1 according to an embodiment 2.

FIG. 11 is a diagram illustrating an example of a usage pattern of the head mounted display 5 equipped with the image display device 1 similarly to FIG. 1.

FIG. 12 is a block diagram illustrating a functional configuration of the head mounted display 5 equipped with the image display device 1.

### DESCRIPTION OF THE PREFERRED EMBODIMENTS

### <Embodiment 1>

FIG. 1 is a diagram illustrating a usage pattern of a head mounted display 5 equipped with an image display device 1 according to an embodiment 1 of the present disclosure. The head mounted display 5 is mounted on a head of a user 3. The user 3 can visually recognize the image from the image display device 1 as a virtual image 2 as well as being capable of viewing the outside world. Although FIG. 1 shows a case where an image is displayed on one eye of the user, the image may be displayed on both eyes of the user.

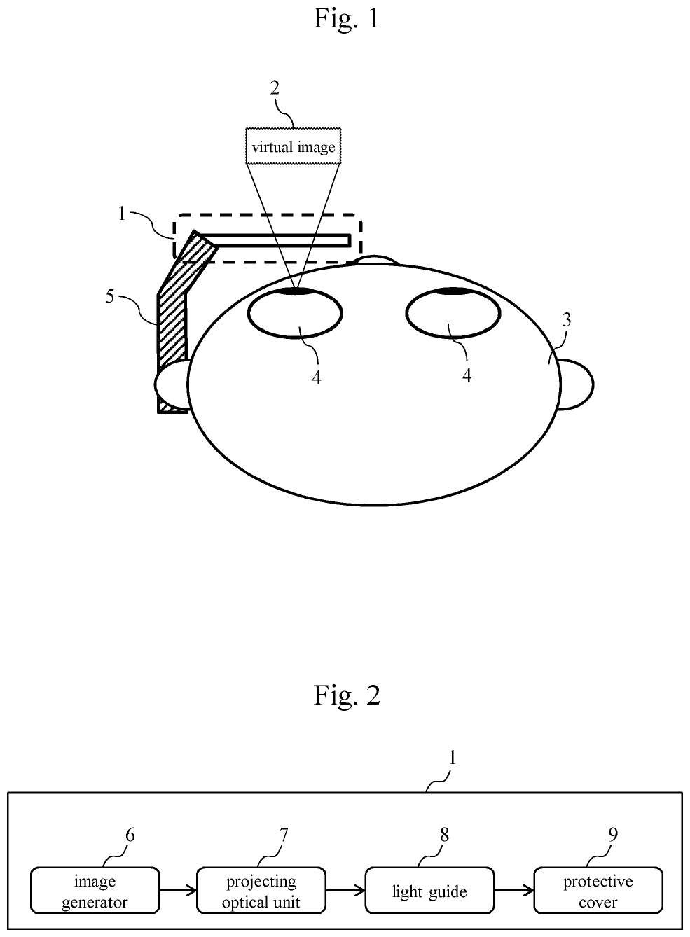

FIG. 2 is a functional block diagram of the image display device 1. The image display device 1 includes an image generator 6, a projecting optical unit 7, a light guide 8, and a protective cover 9.

The image generator 6 includes a light source, an illumination optical unit, and an image generating device for generating an image. Examples of the light source include RGB LEDs (Light Emitting Diode), RGB LDs (Laser Diode), and the like. A white LED may be used as the light source. In this case, it is necessary to equip the image generating element with a color filter.

The illumination optical unit illuminates the light of the light source uniformly to the image generating element. A liquid crystal or a digital mirror device (DMD) may be used for the image generating device. Self-luminous image generating elements such as organic EL or μLED may be used as the image generating device. In this case, the light source and the illumination optical unit are unnecessary, and then it is possible to reduce the size and weight of the image generator.

The projecting optical unit 7 includes a projection lens made of one or more lenses. The projecting optical unit 7 projects an image generated by the image generator.

The light guide 8 is configured to guide the light (image) by totally reflecting the light inside the light guide 8. The light guide 8 can be formed by such as a diffraction grating or a volume hologram, for example. By outputting the light toward the user's eye 4 by means of a plurality of partially reflective surfaces, the head mounted display 5 having see-through properties can be constructed.

The protective cover 9 covers the periphery of the light guide 8 and protects the light guide 8 from scratches and shocks. By having the concave lens and the convex lens respectively on the user side and the external side sandwiching the light guide 8, The light guide 8 corrects the visibility of the image outputted from the light guide 8 and the see-through visibility of the external scenery.

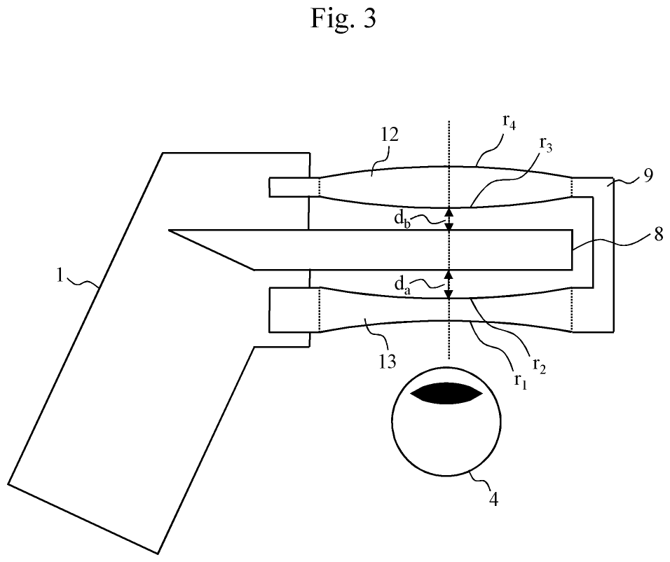

FIG. 3 is a diagram illustrating a configuration example of the protective cover 9 and the light guide 8. The protective cover 9 includes a concave lens 13 and a convex lens 12. The concave lens 13 is positioned between the light guide 8 and the user's eye 4. The convex lens 12 is positioned on the outer side from the light guide 8. A first interval dₐ is formed between the concaved lens 13 and the light guide 8. A second interval d_{b} is formed between the convex lens 12 and the light guide 8.

The concave lens 13 has a curved surface on both sides. The curved surface at the user side has a curvature radius of r₁. The curved surface at the light guide side has a curvature radius of r₂. The convex lens 12 has a curved surface on both sides. The curved surface at the light guide side has a curvature radius of r₃. The curved surface at the outer periphery side has a curvature radius of r₄. Since both curved lenses have two correction surfaces, the correction ability of resolution is higher than that of plano-concave lenses or plano-convex lenses in which one surface is planar. The concave lens 13 and the convex lens 12 may have a meniscus shape. A portion of the concave lens 13 and the convex lens 12 may be an aspherical shape. In this case, by adopting an aspherical shape obtained by adding a higher-order term to the curvature radius, visibility around the field of view is improved.

The image output from the image display device 1 is outputted from the light guide 8 toward the eye 4 of the user, passes through the concave lens 13, and enters the eye 4 of the user. The user can view the image as a virtual image. In the absence of the concave lens 13, the user views the image as projected at infinity. Inside the light guide 8, the image light is copied in order to enlarge the viewpoint range in which the image can be visually recognized. At this time, when inputting the image light projected onto a finite location to the light guide 8, the projected image at the time of copying is also separated into a plurality of images. By projecting the image light to infinity, the image can be projected without splitting. Therefore, the light guide 8 itself can display an image only at infinity.

Due to the configuration above, when the user actually wears the image display device 1, it is necessary to move the line of sight between the output image at infinity and the outside world at a finite distance. There is a problem that the image projected at infinity has poor visibility, the amount of focus movement of the eye 4 of the user is increased, and the feeling of fatigue of the eye 4 increases.

Further, the light guide 8 is thin and fragile, thus the total reflective condition is broken by touching the light guide 8, which causes lack of a part of the image to degrade the image quality. Therefore, users cannot touch the light guide 8. When using the image display device 1, it is desirable to attach the protective cover 9 covering the light guide 8.

In the embodiment 1, in order to solve these problems, the protective cover 9 including the concave lens 13 and the convex lens 12 is employed. By placing the concave lens 13 between the light guide 8 and the user's eye 4, the projected position of the image is corrected by the concave lens 13, which enables bringing the projected position closer to the user side from infinity. The image projection position becomes the focal length of the concave lens 13. As the focal length of the concave lens 13 is shorter, the corrected image projection position approaches the user side.

However, the concave lens 13 causes the scene of the outside world to approach the user, and the sense of perspective of the outside world changes. Therefore, the convex lens 12 is placed at outer side from the light guide 8. The external scene passes through the convex lens 12, the light guide 8, and the concave lens 13 in this order, and enters the eye 4 of the user. At this time, visibility of the scenery of the outside world is corrected by the power (refractive power) of the lens configured by combining the convex lens 12 and the concave lens 13. If the focal length of the concave lens 13 is approximately equal to the focal length of the convex lens 12, the power of the lens configured by combining the concave lens 13 and the convex lens 12 becomes substantially zero. Thus the scenery of the outside world can be visually recognized without any dioptric correction. Therefore, the projected position of only the image from the head mounted display 5 can be corrected so as to approach the user side without changing the viewing distance of the outside world. When using the head mounted display, the user moves the line of sight between the external world at a finite distance and the output image. However, only the image projection position is corrected to the user side, thereby reducing the amount of focus movement of the user, reducing eye fatigue, and improving visibility.

Further, by integrating the concave lens 13 and the convex lens 12 and the protective cover 9, it is possible to have a function of covering and protecting the light guide 8 and a function of correcting the video visibility.

When the protective cover 9 and the light guide 8 are in contact with each other, the total reflection condition of the image light propagating by being totally reflected in the light guide 8 is broken. This causes the light to leak out toward the protective cover, and the image quality is deteriorated by such as lacking a part of the output image. Therefore, in order to maintain the quality of the output image, it is necessary to provide an interval between the protective cover 9 and the light guide 8 so that they do not contact with each other. However, if the interval is too large, stray light is generated and the image quality is deteriorated. Hereinafter, the cause of generation of stray light by the protective cover 9 and the light guide 8 will be described.

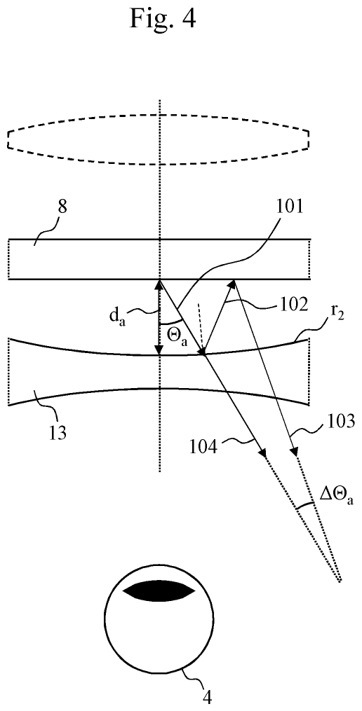

FIG. 4 illustrates two optical paths in which an image 101 outputted from the light guide 8 is incident on the concave lens 13 at an angle θa, travelling toward the user's eye 4. One optical path shows a case where the image 101 is incident on the concave lens 13 and travels straight without being reflected by the concave lens (104). Another optical path shows a case where the image 101 is reflected from the concave lens 13 (102), and is further reflected from the light guide (103). Since the surface of the concave lens 13 has a curvature, a deviation occurs in the reflection angle of 102, which causes an angle difference Δθa between 103 and 104. When the distance dₐ between the light guide 8 and the concave lens 13 is large, the reflection position of 101 is moved away from the center of the concave lens 13, and the reflection angle of 102 is significantly shifted. As a result, the angle difference Δθa becomes large, and the image appears doubled to the user due to the shift, and visibility deteriorates. To suppress the degradation of visibility, it is necessary to specify the distance dₐ between the light guide 8 and the concave lenses 13.

It is assumed now that r₂ is the curvature radius of the concave lens 13 at the side of the light guide 8. Then the angle deviation Δθa is expressed by the following equation.

Δθa=4 sin⁻¹(dₐ tan θa/r₂) (1)

The condition for preventing the user with a visual acuity of 1.0 from recognizing the double image is to suppress the angular deviation Δθa at 1 arc minute or less. Under the condition of Δθa≤1 arc minute, the equation (1) can be transformed with respect to the first interval dₐ as follows.

dₐ≤r₂ sin(1/240°)/tan θa (2)

A case is assumed where the first interval dₐ is maximized. In a biconcave lens having an equal curvature radius at both side and using a material having a refractive index of 1.5, the curvature radius r₂ of the concave lens 13 is calculated to be 10 meters when the focal length is assumed to be a maximum length of 10 meters (this maximum length will be described later). Further, when assuming a head mounted display having a small image field of view of 20 degrees, the incident angle θa of the output image is 10 degrees. The criteria for dₐ in this case is expressed by the following equation.

dₐ≤4 mm (3)

According to Equation (3), in order to suppress the generation of double images and to improve the visibility of images, it is desirable to set dₐ between the light guide 8 and the concave lens 13 to be 4 millimeters or less.

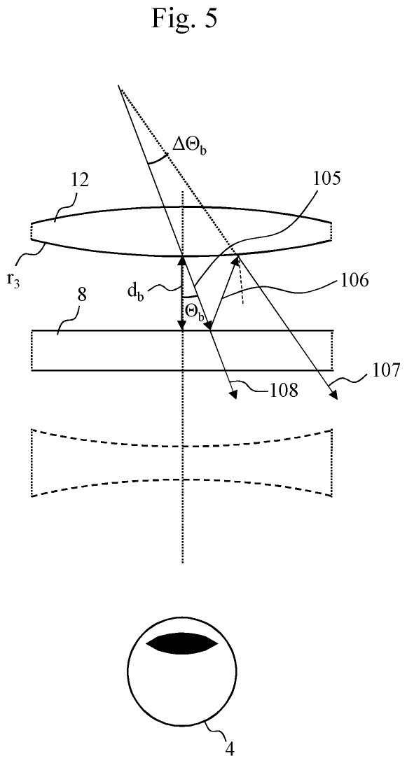

FIG. 5 illustrates two optical paths in which an external scene 105 is incident on the convex lens 12, travelling toward the user's eye 4. One optical path shows a case where the scene 105 of the outside world is incident on the convex lens 12, is not reflected by the light guide 8, and travels straight (108). The other optical path shows a case where the scene 105 of the outside world is reflected from the light guide 8 (106) and further is reflected from the convex lens (107). Since the surface of the convex lens 12 has a curvature, a deviation occurs in the reflection angle of 107, which causes an angle difference Δθb between 107 and 108. When the interval d_{b} between the light guide 8 and the convex lens 12 is large, the reflection position of 106 is away from the convex lens center, so that the reflection angle of 107 is significantly shifted. As a result, the angle difference Δθb becomes large, and the image appears doubled to the user due to the shift, and visibility deteriorates. To suppress the degradation of the visibility, it is necessary to specify the distance d_{b} between the light guide 8 and the convex lens 12.

The curvature radius of the convex lens 12 at the side of the light guide 8 is defined as r₃. The angle deviation Δθb is expressed by the following equation.

Δθb=2 sin⁻¹(d_{b} tan θb/r₃) (4)

The condition for preventing the user with a visual acuity of 1.0 from recognizing the double image is to suppress the angular deviation Δθb at 1 arc minute or less. Under the condition of Δθb 1 arc minute, equation (4) can be transformed with respect to the second interval d_{b} as follows.

d_{b}≤r₃ sin(1/120°)/tan θb (5)

A case is assumed where the second interval d_{b} is maximized. In a biconvex lens having a curvature radius at both side and using a material having a refractive index of 1.5, the curvature radius r₃ of the convex lens 12 is calculated to be 10 meters when the focal length is assumed to be a maximum length of 10 meters (this maximum length will be described later). Since the effective field of view of the human eye is 30 degrees, the incident angle θb of the scene of the outside world is 15 degrees. The criteria for d_{b}in this case is expressed by the following equation.

d_{b}≤5 mm (6)

According to Equation (6), in order to suppress the generation of double images and to improve the visibility of the external scene, it is desirable that d_{b} between the light guide 8 and the convex lens 12 is 5 millimeters or less.

According to the discussion above, in the image display device 1 having the protective cover 9 including the concave lens 13 and the convex lens 12, the distance da between the concave lens 13 and the light guide 8 is arranged at 4 mm or less, the distance db between the convex lens 12 and the light guide 8 is arranged at 5 mm or less, thereby suppressing the visual recognition of stray light, and realizing a high-quality image display.

A configuration has been described so far for canceling the dioptric correction effect of the concave lens 13 by the convex lens 12. Furthermore, as described below, by changing the diopter of the concave lens 13 and the convex lens 12, it is possible to integrate the function of the spectacles for near-sighted or far-sighted into the protective cover 9. Such configuration examples will be described below.

If the focal length of the concave lens 13 is smaller than the focal length of the convex lens 12, the power of the lens configured by combining the concave lens 13 and the convex lens 12 becomes negative, and then the protective cover 9 has a near-sight correction effect on the scenery of the outside world. When the user is myopic, this configuration is useful, and visibility correction of a scene in the outside world is possible without using myopic glasses. Therefore, the image is corrected so that the projected position approaches the user side by the concave lens 13 to increase visibility. At the same time, the scenery of the outside world obtains a negative diopter correction effect obtained by combining the concave lens 13 and the convex lens 12.

If the focal length of the concave lens 13 is larger than the focal length of the convex lens 12, the power of the lens configured by combining the concave lens 13 and the convex lens 12 becomes positive, and then the protective cover 9 has a far-sight correction effect on the scenery of the outside world. When the user is hyperopic, this configuration is useful, and the visibility correction on the outside scene can be performed without using hyperopic glasses. Therefore, the image is corrected so that the projected position approaches the user side by the concave lens to increase visibility. At the same time, the scenery of the outside world obtains a positive dioptric correction effect obtained by combining the concave lens 13 and the convex lens 12.

It is desirable that the projected position of the image outputted by the head mounted display is 0.07 meters or more and 10 meters or less. Therefore, it is desirable that the focal length of the concave lens 13 is 0.07 m or more and 10 m or less. The 0.07 m is the closest distance at which a human can clearly see an object by adjusting the focus of the eye. When the focal length of the concave lens 13 is smaller than 0.07 m, it becomes impossible to focus on the output image. When the focal length of the concave lens 13 is larger than 10 m, the power of the lens is decreased and the correction effect is substantially zero. By setting the focal length of the concave lens 13 to be 0.07 m or more and 10 m or less, an image can be projected onto an appropriate position.

The focal length of the convex lens 12 is desirably 0.07 m or more and 10 m or less, similarly to the concave lens 13. This makes it possible to cancel the power of the lens of the concave lens 13 by the convex lens 12.

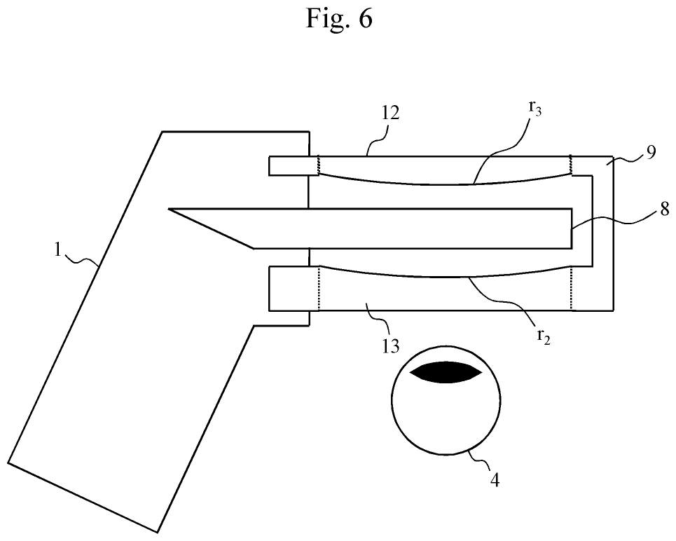

FIG. 6 illustrates a modified example of FIG. 3 in which a surface of the concave lens 13 at a side of the user and a surface of the convex lens 12 at an external side are planar. The curved surfaces of the lens are inside the protective cover 9, and the outside of the protective cover 9 is planar. Therefore, even when the refractive index of the external environment is changed, the power of the lens remains unchanged because the contact surface is planar. For example, when the head mounted display 5 on which the image display device 1 is mounted is mounted and used during swimming, the visibility correction effect can be acquired even in water. In addition, since the outer side of the protective cover 9 is flat, the dirt adhering to the surface is easily removed and the maintenance performance is good.

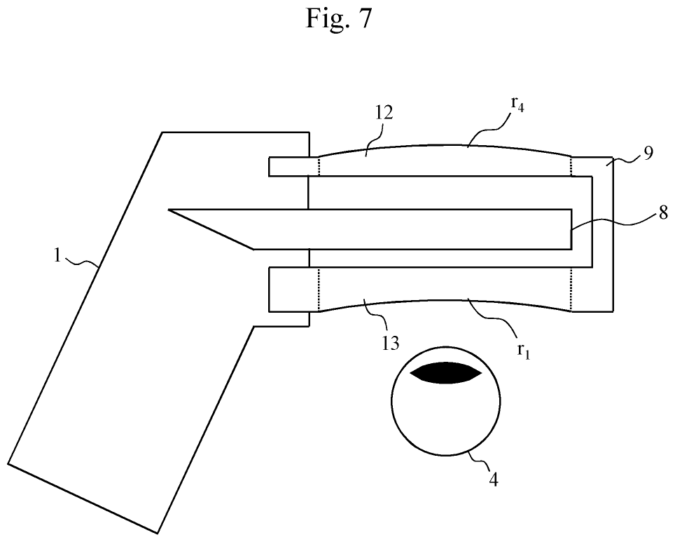

FIG. 7 illustrates a modified example of FIG. 3 in which a surface of the concave lens 13 at a side of the light guide 8 and a surface of the convex lens 12 at a side of the light guide 8 are planar. Since the concave lens surface and the convex lens surface facing the light guide 8 are planar, by attaching the protective cover 9 in parallel with the light guide 8, it is possible to reduce the distance between the lens and the light guide 8 without an extra gap. Then it is possible to reduce the overall thickness totaling the concave lens 13 and the light guide 8 and the convex lens 12. Further, the inside of the protective cover 9 is flat. Thus, for example, when manufacturing the protective cover 9 using a mold, the mold configuration for molding the internal structure of the protective cover 9 can be simplified, which achieves excellent manufacturability and manufacturing cost.

In FIGS. 6 and 7, instead of configuring the one side of the lens as a plane, the one side may be configured spherical having a surface which curvature radius is larger than that of another surface side. Even in this case, the same effects as those of the configurations of FIGS. 6 and 7 can be acquired to some extent. However, it is desirable to configure the surface as a plane as much as possible by increasing the curvature radius as much as possible.

As in FIGS. 6 and 7, even when one surface of the lens is a plane (or a curved surface having a large curvature radius close to a plane), in order to acquire an image correction effect equivalent to the case where both surfaces of the lens are curved, it is necessary to configure the distance between the lens and the light guide 8 closer than the case of both curved lenses. It is therefore noted that the relationships of Equation 3 and Equation 6 are also useful in the case of FIGS. 6 and 7.

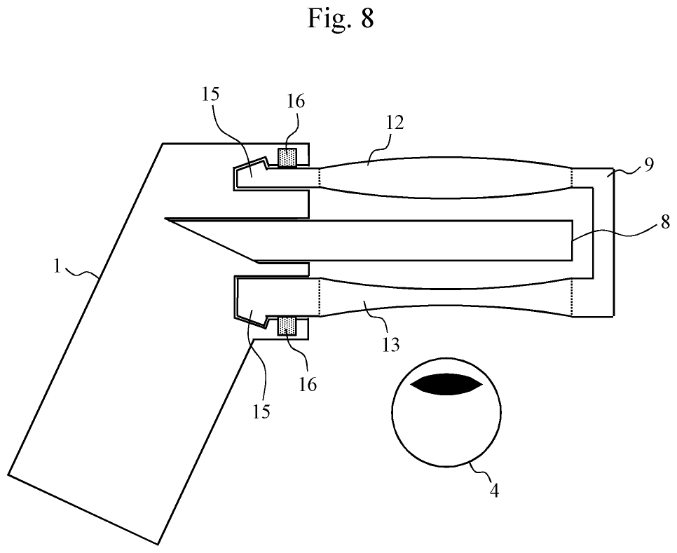

FIG. 8 illustrates a configuration example in which the protective cover 9 comprises a detachable mechanism 15 which is detachable with respect to a housing of the image display device 1. A hook shape shown in FIG. 8 is conceivable as an example of the detachable mechanism 15. The hook shape is a shape having a protrusion at the tip, or is a shape having a bent tip. It is possible to attach and detach the protective cover 9 by hooking the hook shape on the housing of the image display device 1. At this time, the protective cover 9 does not contact with the light guide 8, and is supported by the housing of the image display device 1. The detachable mechanism 15 may be configured by screwing the protective cover 9 to the housing of the image display device 1. The attachment and detachment mechanism by the screw fixes the protective cover 9 more stably than the attachment and detachment using the hook shape. Since the protective cover 9 is detachable, the lens can be replaced, and an appropriate diopter correction effect can be obtained by adjusting the power of the lens in accordance with the visual acuity of the user 3.

A sealing portion 16 is disposed at a portion where the protective cover 9 and the housing is in contact with each other when inserting the protective cover 9 into the housing of the image display device 1. As an example of the sealing portion 16, an O-ring can be used. By sealing between the protective cover 9 and the housing of the image display device 1, the inside of the protective cover 9 is sealed, and thus it is possible to have a waterproof function. In addition, by filling a dry gas such as nitrogen inside the protective cover 9, it is possible to obtain an anti-fogging effect of the light guide 8 and the protective cover 9.

Although FIG. 8 shows a case having both the detachable mechanism 15 and the sealing portion 16, the device may be configured such as comprising the detachable mechanism 15 without the sealing portion 16, or may be configured such as comprising the sealing portion 16 without the detachable mechanism 15.

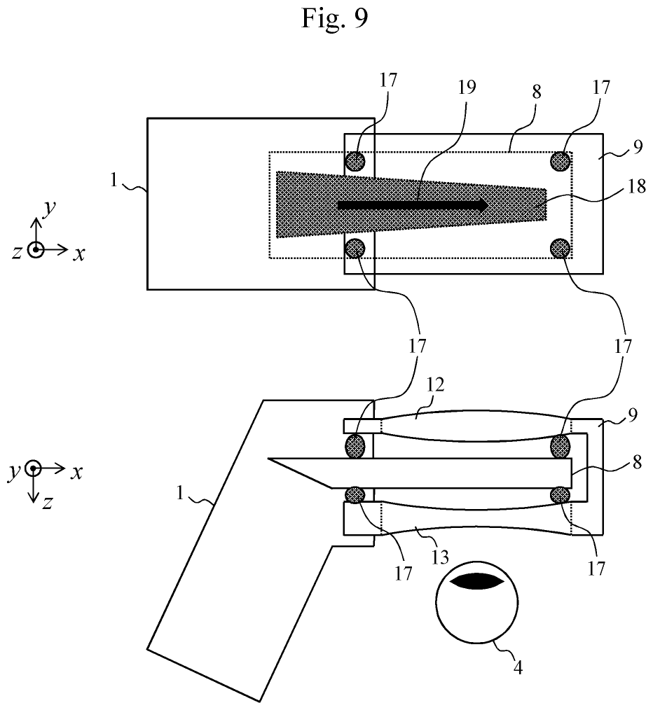

FIG. 9 illustrates a configuration example in which the light guide 8 and the protective cover 9 are bonded together by a support 17. FIG. 9 upper diagram shows a view from the user 3 side, and FIG. 9 lower diagram shows a view from the upper side of the user 3. The image light propagates by being totally reflected within the light propagation range 18 in the light guide 8 along the light guiding direction 19 from the input portion of the light guide 8 toward the output portion of the light guide 8. The light propagation range 18 is different in shape according to the implementation scheme of the light guide 8. In some cases, the light guide 8 is thicker at the input side and becomes gradually narrower toward the output portion, as shown in FIG. 9. In other cases, the light guide 8 is thinner at the input side and becomes gradually thicker toward the output portion.

When the support portion 17 overlaps the light propagation range 18 in the light guide, the total reflection condition in the light guide 8 is broken. Then the light will leak to the support portion 17, and the image quality is deteriorated such as due to lacking a part of the output image. Therefore, the support portion 17 may be adhered to the light guide 8 in the outer region from the light propagation range 18. As an example, the support portion 17 is placed at two peripheral positions on the originating side of the light guide direction 19 and at two peripheral positions on the destination side of the light guide direction 19, totaling four positions. As a result, the quality of the output image can be maintained.

### <Embodiment 2>

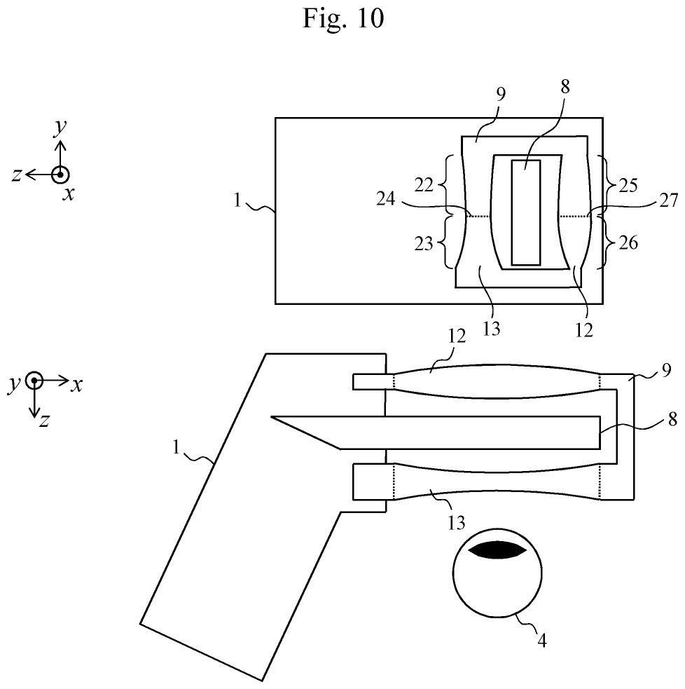

FIG. 10 is a diagram illustrating a configuration example of the image display device 1 according to an embodiment 2 of the present disclosure. In FIG. 10, the same reference numerals as those in FIG. 1 to FIG. 9 denote the same components. Therefore, description for those components is omitted. Although the concave lens 13 and the convex lens 12 in the embodiment 1 are monofocal lenses, the concave lens 13 and the convex lens 12 are configured as multifocal lenses in the embodiment 2. The multifocal lens is divided into at least two or more lens regions, each lens region having a different focal length. Hereinafter, an example will be described where the concave lens 13 and the convex lens 12 are two-focus lenses having two lens areas. However, the concave lens 13 and the convex lens 12 may be multi-focus lenses having three or more focuses, or may be lenses with focus length which changes seamlessly by having a curvature changing continuously (or in stepwise manner). Configurations other than the multifocal lens are the same as those in the embodiment 1.

In FIG. 10, the concave lens 13 is divided into two regions of the concave lens upper region 22 and the concave lens lower region 23, and the convex lens 12 is divided into two regions of the convex lens upper region 25 and the convex lens lower region 26. FIG. 10 upper diagram shows a view from the right side of the user 3. FIG. 10 lower diagram shows a view from the upper side of the user 3. The concave lens upper region 22 and the concave lens lower region 23 has a different focal length, respectively. The convex lens upper region 25 and the convex lens lower region 26 also have different focal lengths, respectively. It is desirable that a joint 24 between the concave lens upper region 22 and the concave lens lower region 23 has a curvature that changes continuously (or in stepwise manner), thereby connecting the two regions seamlessly. It also plies to a joint 27 between the convex lens upper region 25 and the convex lens lower region 26.

It is noted that a curvature changing in stepwise manner means that the curvature changes at a joint between lens regions from one side to another side in stepwise manner (discretely). It is also noted that a curvature changing continuously means that the curvature changes at the joint not discretely but the change is continuous.

If the focal length of the concave lens upper region 22 is smaller than the focal length of the convex lens upper region 25, the power of the lens configured by combining the concave lens 13 and the convex lens 12 becomes negative. Thus the upper region of the protective cover 9 has a near-sight correction effect on the scenery of the outside world. If the focal length of the concave lens lower region 23 is larger than the focal length of the convex lens lower region 26, the power of the lens configured by combining the concave lens 13 and the convex lens 12 becomes positive, the lower region of the protective cover 9 has a far-sight correction effect on the scenery of the outside world. For example, when the user has myopia and presbyopia vision, this configuration allows the visibility of the outside field to be corrected in each of the upper and lower portions of the protective cover 9 without using a near and far range glasses. In addition, the image projection position can be changed closer.

If the focal length of the concave lens lower region 23 is smaller than the focal length of the concave lens upper region 22, the image projection position in the lower region comes closer as compared to the upper region. A human sees an object at a long distance in an upper region of the field of view, and sees an object at a short distance in a lower region of the field of view. With this configuration, the image projection position can be approached to a finite distance of the object in the upper region of the field of view that sees objects at a long distance, and the image projection position can be approached to the closer vicinity in the lower region of the field of view that sees objects at a short distance. By bringing the image projection position closer to the object position in each of the upper and lower regions of the field of view, the amount of focus movement of the user is reduced and eye fatigue can be reduced.

To summarize the configuration above, it can be described as follows. The concave lens 13 is divided into at least two or more regions, the divided regions of the concave lens 13 have different focal lengths respectively, the convex lens 12 is divided into at least two or more regions, and the divided regions of the convex lens 12 have different focal lengths respectively. Thus, the image projection position can be made close to the object position in each of the upper and lower part of the field of view. Therefore, the amount of focus movement of the user is reduced, and the fatigue of the eyes can be reduced.

Alternatively, it may be explained as follows. The concave lens 13 is divided into at least two or more regions, the divided regions of the concave lens 13 have different curvatures respectively, the joints of the respective regions are seamlessly connected by varying the curvatures in stepwise manner, the convex lens 12 is divided into at least two or more regions, the divided regions of the convex lens 12 have different curvatures respectively, and the joints of the respective regions are seamlessly connected by varying the curvatures continuously (or in stepwise manner). Thus, the image projection position can be made close to the object position in each of the upper and lower part of the field of view. Therefore, the amount of movement of the user's focus is reduced, the fatigue of the eyes can be reduced. In addition, the region is seamlessly connected, so that the boundary is not conspicuous.

### <Embodiment 3>

In an embodiment 3 of the present disclosure, a specific example of a head mounted display 5 in which the image display device 1 described in the embodiments 1 to 2 is mounted will be described.

<Embodiment 3: Example of the Method of Changing the Displayed Content with Respect to the Image Projection Position>

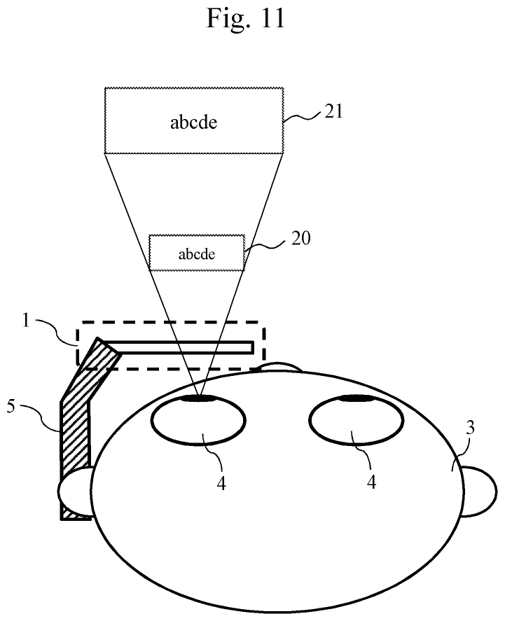

FIG. 11 is a diagram illustrating an example of a usage pattern of the head mounted display 5 equipped with the image display device 1 similarly to FIG. 1. The head mounted display 5 is mounted on the head of the user 3, and the user 3 visually recognizes the image from the image display device 1 as a virtual image in a state in which the outside world is visible. FIG. 11 shows the projected position of the virtual image divided into two patterns. A virtual image projected at a short distance is indicated by 20, and a virtual image projected at a long distance is indicated by 21. Human visual acuity varies with distance, and distance vision is higher than near distance vision. In other words, objects at long distances are more clearly visible than objects at short distances, and fine structures can be visually recognized. When the image display device 1 projects an image, the displayed contents are enlarged when projecting the image at a short distance, and the displayed contents are shrinked when projecting the image at a long distance. Thereby information can be appropriately provided in accordance with human visibility.

### <Embodiment 3: Functional Configuration of Head Mounted Display>

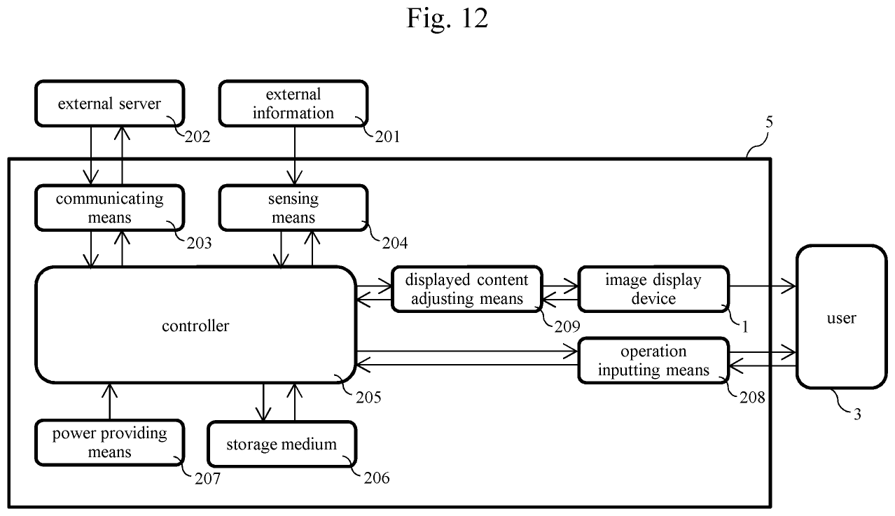

FIG. 12 is a block diagram illustrating a functional configuration of the head mounted display 5 equipped with the image display device 1. In addition to the image display device 1, the head mounted display 5 includes a controller 205 that controls the overall operation of the head mounted display 5, a sensing unit 204 that acquires external information 201, a communicating unit 203 that communicates with the external server 202, a power supplying unit 207, a storage medium 206, and an operation inputting unit 208. The control lines and information lines indicate what is considered to be necessary for the explanation, and do not necessarily indicate all the control lines and information lines.

The external information 201 includes, for example, the posture, orientation, and movement of the user 3, brightness of the outside world, sound, and spatial information.

The sensing unit 204 detects the posture, orientation, and movement of the user 3. Examples of such sensing unit 204 include an inclination sensor, an acceleration sensor, and a GPS sensor. The sensing unit 204 may also detect the brightness, sound, spatial information, and the like of the outside world. Examples of such sensing unit 204 include an imaging device such as an illuminance sensor, a sound sensor, and an infrared sensor.

The communicating unit 203 is a communication device accessible to the external servers 202 (e.g., electronic devices such as smartphones, tablets, PCs, etc.), and can be realized by, for example, Bluetooth (registered trademark) or Wifi (registered trademark).

The operation inputting unit 208 receives an operational instruction for the head mounted display 5 from the user 3. The operation inputting unit 208 may be implemented, for example, by voice recognition using a sound sensor, touch panel input using a pressure-sensitive sensor or a capacitive sensor, gesture input using an infrared sensor, or the like.

The displayed content adjusting means 209 may be implemented by a method of enlarging and reducing the displayed content according to the distance of the image projection position as shown in FIG. 11. By appropriately adjusting the displayed content in accordance with the usage environment of the user 3, visibility can be improved.

### <Modifications of the Present Disclosure>

The present disclosure is not limited to the above-described embodiments, and various modifications are included. For example, the above-described embodiments have been described in detail for the purpose of illustrating the present disclosure easily, and are not necessarily limited to those comprising all the described configurations. It is also possible to replace a part of the configuration of one embodiment with the configuration of another embodiment, and it is also possible to add the configuration of another embodiment to the configuration of one embodiment. Further, it is possible to add, delete, or replace a part of the configuration of each embodiment.

In the embodiments above, the functional units such as the controller 205 or the display content adjustment unit 209 included in the head mounted display 5 can be configured by hardware such as a circuit device in which the function is implemented, or can be configured by software in which the function is implemented being executed by a computing device.

What is claimed is:

1. An image display device for projecting an image to a user, comprising:
an image generator that generates image light;
a projecting optical unit that projects the image light;
a light guide that propagates the image light to the user; and
a protective cover that covers a periphery of the light guide;
wherein the protective cover includes a concave lens and a convex lens disposed opposite to each other across the light guide,
wherein the concave lens is disposed at a position receiving the image light emitted from the light guide,
wherein the convex lens is disposed at a position emitting light from external field toward the light guide,
wherein a distance between the concave lens and the light guide is 4 millimeters or less, and
wherein a distance between the convex lens and the light guide is 5 millimeters or less.

2. The image display device according to claim 1,
wherein a focal length of the concave lens is 0.07 meters or more and 10 meters or less.

3. The image display device according to claim 1,
wherein a focal length of the convex lens is 0.07 meters or more and 10 meters or less.

4. The image display device according to claim 1,
wherein at least one of the concave lens or the convex lens has an aspherical surface portion.

5. The image display device according to claim 1,
wherein the concave lens has a first lens surface having a first curvature radius,
wherein the concave lens has a second lens surface having a second curvature radius larger than the first curvature radius or configured as a plane,
wherein the convex lens has a third lens surface having a third curvature radius, and
wherein the convex lens has a fourth lens surface having a fourth curvature radius larger than the third curvature radius or configured as a plane.

6. The image display device according to claim 1, further comprising a detachable mechanism capable of attaching and detaching the protective cover to and from a housing of the image display device.

7. The image display device according to claim 6,
wherein the detachable mechanism includes:
a structure for fixing the protective cover using a hook by inserting the protective cover into the housing;
or,
a structure for screwing the protective cover to the housing.

8. The image display device according to claim 1, further comprising a sealing member for sealing a gap between the housing of the image display device and the protective cover.

9. The image display device according to claim 1,
wherein the concave lens is bonded to the light guide at each of four support portions forming a rectangular shape,
wherein the convex lens is bonded to the light guide at each of four support portions forming a rectangular shape, and
wherein each of the support portions is disposed, when projected onto a plane in which the image light in the light guide propagates, at a position that does not overlap with an area in which the image light propagates in the light guide.

10. The image display device according to claim 1,
wherein one or both of the concave lens and the convex lens is a multifocal lens.

11. The image display device according to claim 10,
wherein a part of the concave lens is configured as a first concave lens having a first focal length,
wherein a portion other than the first concave lens of the concave lens is configured as a second concave lens having a second focal length different from the first focal length,
wherein a part of the convex lens is configured as a first convex lens having a third focal length, and
wherein a part of the convex lens other than the first convex lens is configured as a second convex lens having a fourth focal length different from the third focal length.

12. The image display device according to claim 10,
wherein a part of the concave lens is configured as a first concave lens having a first curvature,
wherein a portion other than the first concave lens of the concave lens is configured as a second concave lens having a second curvature different from the first curvature,
wherein a part of the convex lens is configured as a first convex lens having a third curvature,
wherein a part of the convex lens other than the first convex lens of the convex lens is configured as a second convex lens having a fourth curvature different from the third curvature,
wherein a boundary between the first concave lens and the second concave lens is configured such that a curvature of the boundary varies continuously or in stepwise manner between the first curvature and the second curvature, and
wherein a boundary between the first convex lens and the second convex lens is configured such that a curvature of the boundary varies continuously or in stepwise manner between the third curvature and the fourth curvature.

13. A head mounted display for projecting an image to a user when worn by the user, comprising:
the image display device according to claim 1;
an operation unit that receives an instruction for the head mounted display from the user; and
a controller that controls the image display device;
wherein the image display device is configured to emit the image light to a position of an eye of the user when the user wears the head mounted display, and
wherein the controller controls the image display device according to the instruction received by the operation unit.

14. The head mounted display according to claim 13, further comprising a display adjustor that adjusts a size of the image light,
wherein the display adjustor projects the image light in a first size when projecting the image light onto a position at a first distance from the user's eye, and
wherein the display adjustor projects the image light in a second size smaller than the first size when projecting the image light onto a position at a second distance longer than the first distance from the user's eye.
